(19) United States
(12) Patent Application Publication
(10) Pub. No.: US 2026/0009637 A1
(43) Pub. Date: Jan. 8, 2026

(54) COHERENT SPECTROSCOPY FOR TSV

(71) Applicant: NOVA LTD., Rehovot (IL)

(72) Inventors: Gilad Barak, Rehovot (IL); Ido Adam, Rehovot (IL); Yishai Schreiber, Rehovot (IL); Amir Sagiv, Rehovot (IL); Amir Shayari, Rehovot (IL)

(73) Assignee: NOVA LTD., Rehovot (IL)

(21) Appl. No.: 19/117,374

(22) PCT Filed: Nov. 13, 2023
(86) PCT No.: PCT/IL2023/051172

§ 371 Date: Mar. 31, 2025

Related U.S. Application Data
(60) Provisional application No. 63/424,914, filed on Nov. 13, 2022.

(51) Int. Cl. G01B 11/24

(52) U.S. Cl. CPC G01B 11/2441; G01B 2210/56

(57) ABSTRACT

A system and methods for OCD metrology are provided including setting an interferometry mirror of the system at each of multiple positions z, wherein at each position the mirror reflection is Optical-Path-Difference (OPD) matched with reflection from the at least one reflective surface, and measuring interferometer spectra I_{measured}, with the mirror at each of the multiple positions; then fitting the multiple measured interferometer spectra to an equation for I_{measured}, to solve for non-z-dependent parameters of the equation, leaving a z-dependent function of the wave number k, having fully coherent and partially coherent terms; and removing the partially coherent terms of the function to derive a fully coherent field for characterizing the OCD structure.

### FIELD OF THE INVENTION

The present invention relates generally to the field of optical inspection of integrated circuit wafer patterns, and in particular to algorithms for measurement of wafer pattern parameters.

### BACKGROUND

Integrated circuits (ICs) are produced on semiconductor wafers through multiple steps of depositing, altering, and removing thin layers, which build up into stacked structures on the wafers. These stacked structures, also referred to as “stacks” or “features,” may be formed in patterns, which, like diffraction gratings, have optical properties.

Optical critical dimension (OCD) metrology employs methods of scatterometry, that is measurement of reflected light radiation from structures formed on a sample (i.e., a wafer) during IC production. Common scatterometry methods include spectral reflectometry (SR), spectral ellipsometry (SE) and spectral interferometry (SI). Scatterometric measurements are commonly applied for OCD metrology during IC production to determine whether wafer patterns are being fabricated with correct (i.e., valid) parameters. Measurements may determine the extent of variation from design specifications. Manufacturing protocols may specify allowed deviations from mean values.

Scatterometry methods face a serious challenge when measuring thick structures, particularly structures with several reflective surfaces that are significantly separated from each other. One common application with these characteristics is “through-silicon via” (TSV) manufacturing, which is an interconnect structure with dimensions reaching tens of microns and even exceeding 100 μm. Other examples are ultra-thick dielectrics, CMOS image sensors and various structures used in advanced semiconductor packaging.

The interference of reflections from surfaces at different heights causes oscillation of the measured reflection as a function of wavelength, that is, the reflection is significantly changed for extremely small wavelength differences. When the difference is great, the measured spectrum may be ‘smeared’ with spectral features that cannot be resolved by the measurement. Such situations lead to loss of sensitivity and applicability of the metrology solution.

In order to resolve spectral features for such structures, the measurement apparatus (e.g. spectrometer) may need to have an extremely high spectral resolution. However, this increases cost and complexity, and still does not solve the problem for very thick structures. Moreover, such solutions are not scalable, as semiconductor applications become thicker, high-end spectrometers cannot keep up with the required spectral resolution.

In such situations, the measured spectrum is ‘smeared’ with spectral features unresolved by the measurement. Such situation leads to loss of sensitivity and applicability of the metrology solution.

A possible approach involves using longer wavelengths, i.e. infrared and mid-infrared). This leads to slower oscillations at longer wavelengths, but also results in lost sensitivity, as higher wavelengths better distinguish certain structures. Longer wavelengths also increases system complexity, increase measurement times (due to lower brightness light sources and lower efficiency detectors), and increase necessary measurement spot size (due to diffraction of the longer wavelengths).

Using small numerical-aperture measurements can improve results, as the angular span of incident light is another factor leading to coherence loss. By reducing this angular span, spectral contrast can be increased. Of course, such limitation has direct negative impact on the light flux, causing increased noise.

Another approach to the spectral resolution challenge is provided by monochromator-based solutions, where a scanning element measures the scattered light at a specific wavelength at any given instant. High spectral resolutions are attainable, but at the expense of long measurement times, commonly unsuitable for process control and high throughput metrology.

Another alternative for increased spectral resolution is provided by Fourier-based methods. In such methods an integral over a broad spectral range is measured, but using a scanning element (typically a mirror) different measurement instances capture different weighted-sums of the signal. Methods in this category are Fourier-Transform IR (FTIR) and White Light Interferometry (WLI). Typically, the eventual spectral resolution is proportional to the range across which the scanning element is swept, allowing very high spectral resolutions. However, as before, high resolutions come at the direct expense of measurement time.

### SUMMARY

Embodiments of the present invention provide systems and methods for use in optical critical dimension (OCD) metrology, based on optical path difference (OPD) matched interferometry, in accordance with an embodiment of the present invention.

### BRIEF DESCRIPTION OF DRAWINGS

For a better understanding of various embodiments of the invention and to show how the same may be carried into effect, reference is made, by way of example, to the accompanying drawings. Structural details of the invention are shown to provide a fundamental understanding of the invention, the description, taken with the drawings, making apparent to those skilled in the art how the several forms of the invention may be embodied in practice. In the figures:

FIG. 1 is a schematic diagram of a system for optical critical dimension (OCD) metrology, with optical path difference (OPD) matched interferometry, in accordance with an embodiment of the present invention;

FIGS. 2A and 2B are graphs showing the effect of partial coherence on signal amplitude;

FIG. 3 is a schematic diagram showing spectroscopic examination of a complex with multiple surfaces, including one surface at a depth beyond the range of full coherence with the higher surfaces;

FIG. 4 is a graph of a Fourier transform of a field in the wave number (or frequency) domain to a time-domain impulse response; and,

FIG. 5 is a flow diagram depicting a process for characterizing OCD metrology, with OPD-matched interferometry, in accordance with an embodiment of the present invention.

### DETAILED DESCRIPTION

Embodiments of the present invention provide systems and methods for use in optical critical dimension (OCD) metrology, based on optical path difference (OPD) matched interferometry, when the distance between surfaces causes partial coherence.

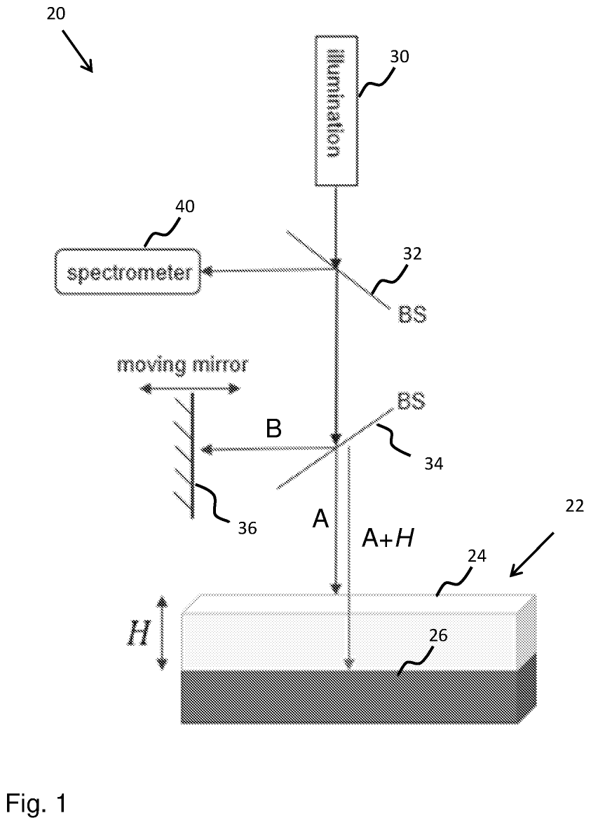

FIG. 1 is a schematic diagram of a system 20 for spectral interferometry metrology of a wafer, indicated as a sample 22, wherein there are at least two reflective surfaces under measurement, a top surface 24, and a bottom surface 26, separated by a distance H.

Light from a light source 30 (typically of a predetermined range of wavelengths) passes a first beam-splitter 32 and is directed towards the structure under measurement. Light is then split by a second beam-splitter 34, one fraction directed towards the sample and another fraction towards a mirror 36.

After reflection from the sample and mirror, the light from both is re-combined to be collected by a spectrometer 40. An SI measurement involves collecting a few spectra at different positions of the interferometer mirror 36.

In embodiments of the present invention, the mirror position is “matched” to reflective surfaces of the structure being measured, such that an optical path difference (OPD) of reflected light is equal to zero. For example, OPD-matching of the mirror with the top surface involves setting the distance B (the distance of the mirror to the beam splitter 34) to the distance A (the distance from the beam splitter to the surface). OPD-matching of the bottom surface involves setting B to A+H.

The optical path length of each path is the product of the geometric length and the refractive index of the material through which the light is propagating. Inside a structure each electromagnetic eigenmode has a different phase velocity and hence a different effective refractive index and a different OPD. In short, OPD-matching involves tuning a system to a specific value, or range of values, of the OPD.

The system 20 may operate within a production line (not shown) for production and monitoring of structures of a wafer. Additional details of spectral interferometry (SI). and its underlying principles can be found in the U.S. Pat. No. 10,161,885 and PCT Patent No. PCT/IB2022/050774, both in the name of Nova Ltd. and incorporated herein by reference. Additional components, such as polarization control at illumination and collection, beam shaping, etc., can be added to the apparatus but are disregarded here for clarity.

Additional components of such systems may include imaging lenses, polarizing filter(s), variable aperture stops, and motors. Operation of such elements is typically automated by computer controllers, which may include I/O devices and which may also be configured to perform data processing tasks, such as generating scatterometry data, which may include a spectrogram, also referred to herein as spectra. The spectra which may be represented in vector form, whose data points are measures of reflected light intensity at different light wavelengths (or wave numbers or frequencies). In typical OCD metrology, the range of light that is measured may cover the visible light spectrum and may also include wavelengths in ultraviolet and infrared regions. A typical spectrogram output for OCD metrology may have, for example, 245 data points covering a wavelength range of 200 to 970 nm.

When there are reflections from two interfaces (also referred to herein as “surfaces”), separated by a thickness H, the reflections acquire a phase difference, which results in oscillatory spectral behavior. Fourier analysis of the reflected spectra reveals distinct peaks, with separation between the peaks directly proportional to the stack height H.

The challenge posed by such cases relates to the ability of a practical measurement system to resolve these fast spectral features. When the spectral oscillations cannot be resolved by the measurement apparatus (usually, using a spectrometer), the resulting data is smeared resulting in contrast loss of the spectrum. Furthermore, the angular-dependence of the reflected spectrum can be extremely high; because measurements involve acquisition of a range of incident angles, such high dependence can similarly cause smearing of the measured spectra. Under such conditions, sensitivities are drastically reduced, to the degree that some attributes cannot be reliably measured.

The effect of spectral smearing (due to either of these effects) can be described in terms of coherence loss. Due to the finite spectral resolution of a spectrometer, instead of measuring an oscillatory intensity I(k), it measures a smeared intensity:

$$I ( k ) = {\int }_{- ∞}^{∞} {dk}^{′} K ( {k}^{′} , k ) I ( {k}^{′} )$$

where K (k′, k) is a weighting function describing the details of the spectral smearing. For the sake of simplicity of demonstration, we take

$$K ( {k}^{′} , k ) = \frac{1}{\sqrt{2 π}} {e}^{- \frac{{( {k}^{′} - k )}^{2}}{2 {σ}^{2}}} ,$$

i.e. a Guassian centered at k.

Without mirror reflectivity, interference of light reflected from the top and bottom interfaces can be described by the following equation:

$$\hat{I} ( k ) = {\vert {r}_{top} \vert}^{2} + {\vert {r}_{bot} \vert}^{2} + 2 {e}^{- 2 {σ}^{2} {H}^{2}} \vert {r}_{top} {r}_{bot} \vert cos ( {ϕ}_{t b} ( {k}^{′} ) + 2 {k}^{′} H )$$

However, when H is large enough, the coherent term (the cosine) is suppressed. In general, instead of a Gaussian suppression, we may use a more general suppression factor γ(k), which depends on the exact form of K(k′, k). It may be noted that when γ=0 (or very close to zero), the resulting intensity involves only the incoherent summation over the two reflection terms:

$${I}_{incoherent} = {\vert {r}_{top} \vert}^{2} + {\vert {r}_{bot} \vert}^{2}$$

Spectral smearing causes coherence loss both considering interference between the top and bottom stack reflections (γ) and reflection from the stack bottom and the mirror (γ′), where y is the coherence for OPD 2nH and y′ is the coherence for OPD 2(nH-z). For a Gaussian K(k′, k), y=e^{2(2nH)}^{²}^{σ}^{²} and y′=e^{2(2nH-z)}^{²}^{σ}^{²}).

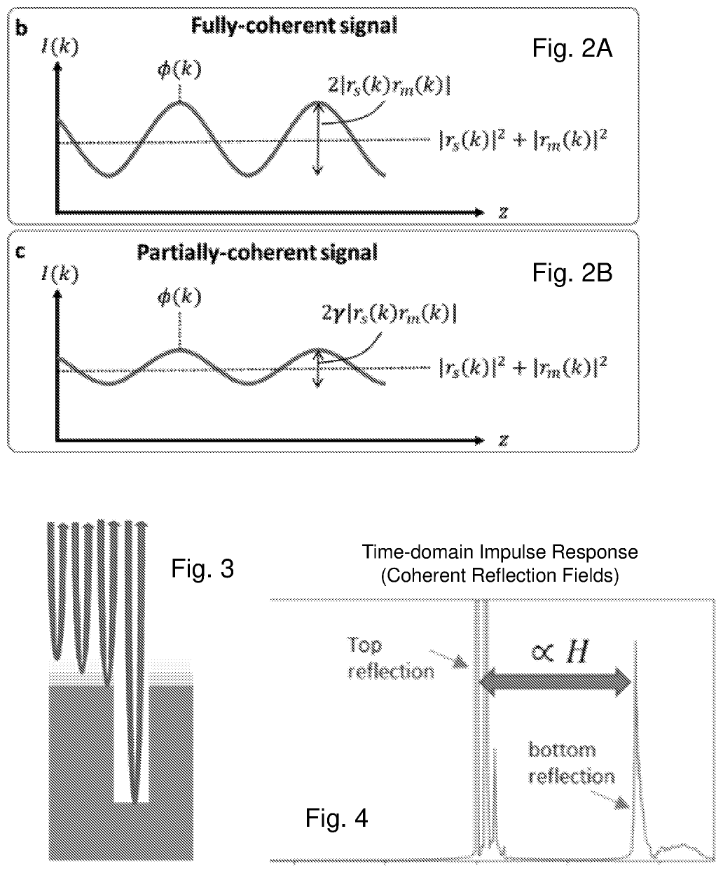

FIGS. 2A and 2B are graphs showing the effect of partial coherence on signal amplitude.

FIG. 3 is a schematic diagram of a structure having two regions of reflection, separated by a thickness H. Reflections from the bottom interface acquire an additional phase term, causing the spectrogram output to be highly oscillatory due to interference.

Fourier analysis of the reflected spectrum, shown as an impulse response, time domain function in FIG. 4, reveals distinct peaks, with the separation between the top and bottom surfaces directly proportional to the stack height H. When the structure top surface is comprised of a nontrivial structure, with multiple layers, the Fourier transforms, [symbol] (|rₜₒₚ|²+|r_{bot}|²)(z) and [symbol] (γ|rₜₒₚr_{bot}|e^{±iϕ}^{_{tb}})(z) have multiple peaks about z=0 and multiple frequencies will appear in the reflected spectrum (see FIG. 3). In such a situation, it could be extremely difficult to isolate the stack height information from the measurement.

However, the bottom surface impulse response may be removed from the time domain, thus removing this signal from the wave number domain after further Fourier transformation.

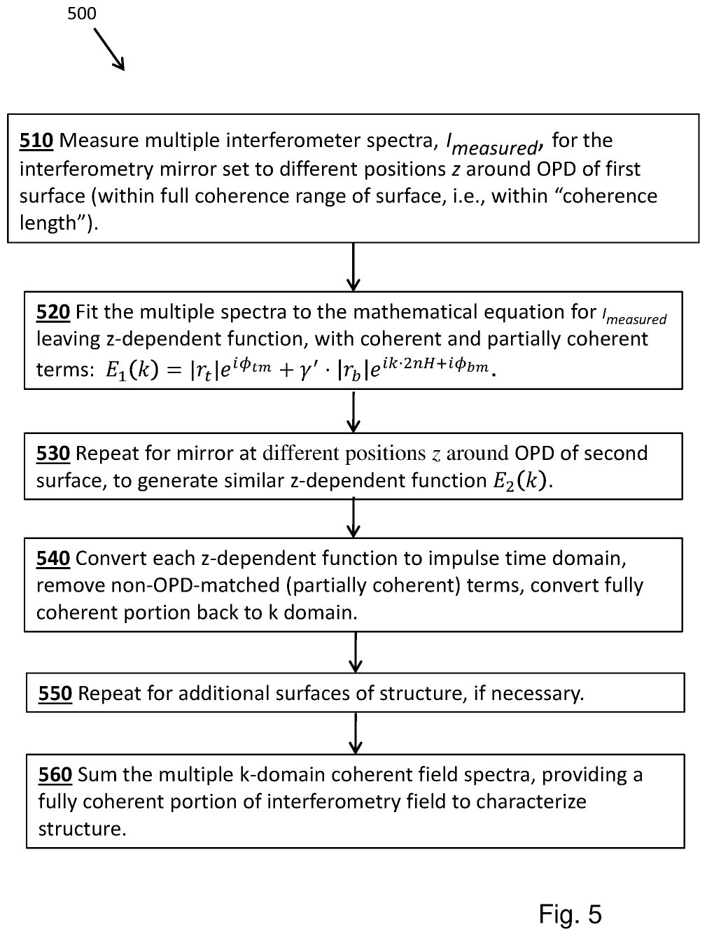

FIG. 5 is a flow diagram depicting a computer-implemented process 500 for characterizing a structure under measurement.

It should be noted that An SI measurement provides a complex reflected field rₛ(k)=|rₛ(k)|e^{iϕ}^{ₛ}^{(k)}: both amplitude and phase of the reflected field are collected. The reflected amplitude can be obtained using standard reflectometry, where the measured intensity l(k)=|rₛ(k)|² is used. Such a measurement is highly stable and simple to implement.

The spectral phase, however, can only be measured using the interferometer mirror and involves acquiring measurements at few mirror positions

As described above, it is crucial to use the z-dependent term to extract both phase and amplitude of the reflected complex field.

In many important cases, the fast (coherent) oscillations are crucial for metrology as they hold the direct sensitivity to parameters of interest. One such situation is measurement of depth for TSV (or thickness of thick layers): a standard approach involves using Fourier analysis on the oscillating spectrogram.

Therefore, suppression of the coherent field typically significantly limits the quality of interpretation of the spectrum.

The method of the present invention involves using at least two SI measurements, when the interferometer mirror is OPD-matched to each reflecting interface of interest. When the mirror is OPD-matched to a top surface, spectral smearing affects the interference of the bottom. However, interference with the top surface is fully coherent.

Similarly, when the mirror is OPD-matched to a bottom interface, spectral smearing affects the interference of the top. However, interference with the bottom interface is fully coherent.

It is not important if the mirror is OPD-matched at some separation from the top or the bottom interface; as long as such separation is within the “coherence length” of the system. Measurements made with OPD-matching at multiple positions that are within the coherence length will be highly coherent.

Extraction of the coherent fields (i.e., coherent between the mirror and respective surfaces) can be performed by the following steps of process 500.

At a step 510, multiple interferometer spectra, I_{measured}, are measured, with the interferometry mirror set to different positions zᵢ around a point at which OPD is zero with respect to a first surface. In other words, all measurement fall within a full coherence range of the first surface, i.e., within the “coherence length” (such that no “partial coherence” factor is needed). As one example, we may refer to a highest surface to be analyzed (closest to the light source) as a “top” surface. If there are multiple, distinguishable height differences between surfaces, they may each be measured by separate OPD-matching.

At a step 520, the multiple measured spectra are fit to a mathematical equation for I_{measured}, which may be defined, for example, as:

$${I}_{measured} ( k , z ) = {\vert {r}_{m} \vert}^{2} + {\vert {r}_{t} \vert}^{2} + {\vert {r}_{b} \vert}^{2} + 2 γ [ \vert {r}_{t} {r}_{b} \vert cos ( 2 knH + {ϕ}_{tb} ) ] + 2 R [ \vert {r}_{m} \vert {e}^{- 2 izk} ( \vert {r}_{t} \vert {e}^{i {ϕ}_{tm}} + {γ}^{′} \vert {r}_{b} \vert {e}^{i ( 2 knH + {ϕ}_{bm} )} )$$

where,
k is the wave number

$$( = \frac{2 π}{λ} )$$

at each interferometer measurement;
zᵢ is the mirror position for each of the i measurements;
ϕ(k) is the wavelength-dependent reflected phase difference, for the respective pairs of reflections, tb (top-bottom), tm (top-mirror), and bm (bottom-mirror);
H is the geometric difference between the interfaces;
n is the refractive index of the structure;
rₘ, rₜ, r_{b} are reflectivities, responsively of the mirror, the top surface and the bottom surface, all being functions of k;
γ is the coherence for OPD 2nH;
γ′ is the coherence for OPD 2(nH−z); and
R is the real function of a function with an imaginary part.

Coherence γ is defined as the ratio between the measured interference term and the interference expected for completely coherent fields (which can be measured, for example, by moving one of the mirrors in a Michaelson interferometer and measuring the amplitude of the resulting oscillations).

The multiple measured spectra are then fit it to the expected functional form by minimizing

$${\sum }_{i = 1}^{N} {\vert {I}_{measured} ( k , {z}_{i} ) - {\vert {r}_{m} \vert}^{2} - {\vert {r}_{t} \vert}^{2} - {\vert {r}_{b} \vert}^{2} - 2 γ [ \vert {r}_{t} {r}_{b} \vert cos ( 2 knH + {ϕ}_{tb} ) ] - 2 R [ \vert {r}_{m} \vert {e}^{- 2 zik} ( \vert {r}_{t} \vert {e}^{i {ϕ}_{tm}} + \vert {r}_{b} \vert {e}^{i ( 2 knH + {ϕ}_{bm} )} ) \vert}^{2}$$

When the OPD is matched to the bottom surface (Step 530), the equation for fitting is then:

$${I}_{measured} ( k , z ) = {\vert {r}_{m} \vert}^{2} + {\vert {r}_{t} \vert}^{2} + {\vert {r}_{b} \vert}^{2} + 2 γ [ \vert {r}_{t} {r}_{b} \vert cos ( 2 knH + {ϕ}_{tb} ) ] + 2 R [ \vert {r}_{m} \vert {e}^{- 2 izk} ( \vert {r}_{b} \vert {e}^{i {ϕ}_{tm}} + {γ}^{′} \vert {r}_{t} \vert {e}^{i ( 2 knH + {ϕ}_{bm} )} )$$

With a similar fitting equation for minimization. The non-z-dependent terms can then be cancelled out, as common to all mirror positions, leaving functions that are dependent on z, for the top and bottom, respectively. It may be noted that some terms of I_{measured}(k, z) may also be derived separately, and their values substituted into the equation, such as the mirror reflectivity, which does not depend on a given wafer. Also, as noted above, |rₜ|²+|r_{b}|²+2γ[|rₜr_{b}|cos(2khN+ϕ_{tb})] can be measured using ordinary spectral reflectometry. Additional surfaces can similarly be measured by setting the mirror OPD to zero for each additional surface.

The functions extracted from I_{measured}(k, z), that are dependent on z, i.e., the position of the mirror, for two positions, e.g., the top and bottom OPD scenarios respectively, are as follows:

$${E}_{1} ( k ) = {\underbrace{\vert {r}_{t} \vert {e}^{i {ϕ}_{tm}}}}_{{[ {E}_{1} ]}_{Coh}} + {γ}^{′} \cdot \vert {r}_{b} \vert {e}^{ik \cdot 2 nH + i {ϕ}_{bm}}$$

$${E}_{2} ( k ) = {γ}^{′} \vert {r}_{t} \vert {e}^{- ik \cdot 2 nH + i {ϕ}_{tm}} + {\underbrace{\vert {r}_{b} \vert {e}^{i {ϕ}_{bm}}}}_{{[ {E}_{2} ]}_{Coh}} .$$

Each of these functions includes a fully coherent term (as noted below each equation) and a partially coherent term.

The fully coherent term may then be extracted, at a step 540, for example by converting to the impulse time domain, at which the separation of the surfaces is clear, and then removing the data associated with the non-OPD surface.

That is, both E₁(k) and E₂(k) may be converted by a Fourier transform to an impulse time domain. The impulse response from the non-OPD-matched portion may then be removed, and the impulse time domain functions may be converted back to the k domain, providing a fully coherent portion of the interferometry field. Additional details of editing fields in the frequency/wave number domain by transformation to the impulse response domain are described in the above cited PCT Patent No. PCT/IB2022/050774, incorporated herein by reference.

As noted above, the process may be repeated for additional OPD-matched surfaces (indicated as a step 550).

Finally, at a step 560, the multiple k-domain coherent field spectra, may be added together, providing a fully coherent portion of the measured interferometry spectra. For two surfaces of interest, the summation would be a function of the two coherent terms listed above:

$$\begin{matrix}{E}_{Coherent} ( k ) = {[ {E}_{1} ( k ) ]}_{Coherent} + {[ {E}_{2} ( k ) ]}_{Coherent} \cdot {e}^{ik 2 Δ z} \\ = \vert {r}_{t} \vert {e}^{i {ϕ}_{tm}} + \vert {r}_{b} \vert {e}^{i {ϕ}_{bm}} {e}^{ik 2 Δ z}\end{matrix}$$

For additional surfaces, the summation would be a function with additional terms, with the first term, s1, indicative of the reflective surface closest to the light source (i.e., a “top” surface) and the subsequent terms (s2, s3, . . . ) being deeper surfaces, as follows:

$${E}_{coherent} ( k ) = \vert {r}_{s 1} \vert {e}^{i {ϕ}_{s 1 m}} + \vert {r}_{s 2} \vert {e}^{i {ϕ}_{s 2 m}} {e}^{ik 2 Δ {z}_{1}} + \vert {r}_{s 3} \vert {e}^{i {ϕ}_{s 3 m}} {e}^{ik 2 Δ {z}_{2}} + …$$

E_{Coherent}(k) can then be used for various applications in the wafer production process, such as in characterizing a structure, providing greater stability and detail than can be provided by the decoherent interferometry spectra. In one application of the process 500, for example, E_{Coherent}(k) can be derived for a reference wafer, and subsequently, in production, wafers can be measured for E_{coherent}(k) to validate that their structures conform to the desired reference.

It should be noted that the two or more surfaces measured for the derivation of E_{Coherent}(k) are, typically, surfaces from which reflections have partial coherence with each other. When the distance separating relevant surfaces is so great that the reflections from the surfaces have no coherence (γ′=0), there is no need for separating out partially coherent fields from the z-dependent terms of I_{measured}(k, z) for a given OPD-matched surface. In addition, coherent reflections for OPD-matched surfaces can be analyzed separately, without a need to combine multiple surfaces into single fields when characterizing a structure.

It is to be understood that processing elements shown or described herein are preferably implemented by one or more computers in computer hardware and/or in computer software embodied in a non-transitory, computer-readable medium in accordance with conventional techniques, such as employing a computer processor, a memory, I/O devices, and a network interface, coupled via a computer bus or alternate connection arrangement.

Unless otherwise described, the terms “processor” and “device” are intended to include any processing device, such as, for example, one that includes a CPU (central processing unit) and/or other processing circuitry (e.g., GPUs), and may refer to more than one processing device. Various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette, tapes), flash memory, etc. Such memory may be considered a computer readable storage medium.

In addition, phrases “input/output devices” or “I/O devices” may include one or more input devices (e.g., keyboard, mouse, scanner, HUD, etc.) for entering data to the processing unit, and/or one or more output devices (e.g., speaker, display, printer, HUD, AR, VR, etc.) for presenting results associated with the processing unit.

Embodiments of the invention may include a system, a method, and/or a computer program product. The computer program product may include a computer readable storage medium (or media) having computer readable program instructions thereon for causing a processor to carry out aspects of the invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), Blue-Ray, magnetic tape, Holographic Memory, a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. A network adapter card or network interface in each computing/processing device may receive computer readable program instructions from the network and forwards the computer readable program instructions for storage in a computer readable storage medium within the respective computing/processing device.

Computer readable program instructions for carrying out operations of the invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the invention.

Where aspects of the invention are described herein with reference to flowchart illustrations and/or block diagrams of methods, apparatus (systems), and computer program products according to embodiments of the invention, it will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Any flowchart and block diagrams included herein illustrate the architecture, functionality, and operation of possible implementations of systems, methods, and computer program products according to various embodiments of the invention. In this regard, each block in the flowchart or block diagrams may represent a module, segment, or portion of instructions, which may include one or more executable instructions for implementing the specified logical function(s). In some alternative implementations, the functions noted in the block may occur out of the order shown herein. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### EXAMPLES

Examples of the present invention may include the following configurations.

Example 1 is a method for optical critical dimension (OCD) metrology, for characterizing a structure by an interferometry system, when the structure has at least two reflective surfaces, these being at least one reflective surface separated by a distance greater than a coherence length from at least a second reflective surface. The method includes steps:
a) setting an interferometry mirror of the system at each of multiple positions z, wherein at each position the mirror reflection is Optical-Path-Difference (OPD) matched with reflection from the first reflective surface, and measuring interferometer spectra I_{measured}, with the mirror at each of the multiple positions;
b) fitting the multiple measured interferometer spectra to an equation for I_{measured}, to solve for non-z-dependent parameters of the equation, leaving a z-dependent function, E₁(k), of the wave number k, with coherent and partially coherent terms; and
c) removing the partially coherent terms of E₁(k) to provide a coherent field E₁(k) Coherent, for characterizing the OCD structure of the first reflective surface.

A second exemplary method of the present invention includes the features of the first example and further includes repeating steps a) through c) for at least the second reflective surface, to generate a second z-dependent function, E₂(k), including a coherent function, E₂(k)_{Coherent}. A total field E_{Coherent}(k) may then be derived combining the coherent fields of E₁(k) and of E₂(k), for characterizing the OCD structure.

By a third exemplary method, assuming that the first surface is the higher of the first and second surfaces, the derivation of the combined coherent fields can be performed according to an equation, E_{coherent}(k)=[E₁(k)]_{Coherent}+[E₂(k)]_{Coherent}·e^{ik2Δz}, where Δz is the difference between the two OPD-matched mirror locations for the two surfaces.

A fourth example of the present invention is a method including features of any of the above examples, and including steps of removing the partially coherent terms of E₁(k) and E₂(k) by converting each function by a Fourier transform to an impulse time domain, removing the impulse response from the non-OPD-matched portion, and converting the impulse time domain back to the k domain, thereby providing a fully coherent portion of the measured interferometry field, corresponding to an equation E_{coherent}(k)=|rₜ|e^{iϕ}^{ₜₘ}+|r_{b}|e^{iϕ}^{_{bm}}e^{ik2Δz}, for characterizing the OCD structure.

A fifth example of the present invention is a method including features of any of the above examples, and wherein the equation for I_{measured} is

$${I}_{measured} ( k , {z}_{i} ) = {\vert {r}_{m} \vert}^{2} + {\vert {r}_{t} \vert}^{2} + {\vert {r}_{b} \vert}^{2} + 2 γ [ \vert {r}_{t} {r}_{b} \vert cos ( 2 knH + {ϕ}_{tb} ) ] + 2 R [ \vert {r}_{m} \vert {e}^{- 2 izk} ( \vert {r}_{t} \vert {e}^{i {ϕ}_{tm}} + {γ}^{′ \vert {r}_{b} \vert {e}^{i ( 2 knH + {ϕ}_{bm} )}} )$$

wherein the terms are defined as noted hereinabove.

A sixth example of the present invention is a method including features of any of the above examples, and wherein fitting the multiple measured interferometer spectra comprises minimizes the equation:

$${\sum }_{i = 1}^{N} {\vert {I}_{measured} ( k , {z}_{i} ) - {\vert {r}_{m} \vert}^{2} - {\vert {r}_{t} \vert}^{2} - {\vert {r}_{b} \vert}^{2} - 2 γ [ \vert {r}_{t} {r}_{b} \vert cos ( 2 knH + {ϕ}_{tb} ) ] - 2 R [ \vert {r}_{m} \vert {e}^{- 2 zik} ( \vert {r}_{t} \vert {e}^{i {ϕ}_{tm}} + \vert {r}_{b} \vert {e}^{i ( 2 knH + {ϕ}_{bm} )} ) \vert}^{2}$$

It is to be understood that a further example of the present invention is a metrology unit configured to implement any of the above method examples. In addition, a further example of the present invention is non-transitory computer readable medium storing instructions to implement any of the above method examples.

1. A method of optical critical dimension (OCD) metrology for characterizing a structure by an interferometry system, wherein the structure has at least two reflective surfaces, wherein a first reflective surface is separated by a distance greater than a coherence length from at least one second reflective surface, the method comprising:
a) setting an interferometry mirror of the system at each of multiple positions z, wherein at each position the mirror reflection is Optical-Path-Difference (OPD) matched with reflection from the first reflective surface, and measuring interferometer spectra I_{measured}, with the mirror at each of the multiple positions;
b) fitting the multiple measured interferometer spectra to an equation for I_{measured}, to solve for non-z-dependent parameters of the equation, leaving a z-dependent function, E₁(k), of the wave number k, with coherent and partially coherent terms; and
c) removing the partially coherent terms of E₁(k) to provide a fully coherent field E₁(k)_{Coherent}, for characterizing the OCD structure of the first reflective surface.

2. The method of claim 1, further comprising repeating steps a) through c) for at least the second reflective surface, to generate a second z-dependent function, E₂(k), including a fully coherent function, E₂(k) Coherent, and further comprising calculating a derived field E_{Coherent}(k) for characterizing the OCD structure, combining the fully coherent terms of E₁(k) and of E₂(k).

3. The method of claim 2, wherein the second surface is deeper than the first surface and wherein E_{Coherent}(k) is derived by combining the fully coherent terms according to the equation E_{Coherent}(k)=[E₁(k)]_{Coherent}+[E₂(k)]_{Coherent}·e^{ik2Δz}, where Δz is the difference between the two OPD-matched mirror locations for the two surfaces.

4. The method of claim 2, wherein removing the partially coherent terms of E₁(k) and E₂(k) comprises converting each function by a Fourier transform to an impulse time domain, removing the impulse response associated with the non-OPD-matched portion, and converting the impulse time domain back to the k domain, providing a fully coherent portion of the interferometry field.

5. The method of claim 1, wherein the equation for I_{measured} is
$${I}_{measured} ( k , {z}_{i} ) = {\vert {r}_{m} \vert}^{2} + {\vert {r}_{t} \vert}^{2} + {\vert {r}_{b} \vert}^{2} + 2 γ [ \vert {r}_{t} {r}_{b} \vert cos ( 2 knH + {ϕ}_{tb} ) ] + 2 R [ \vert {r}_{m} \vert {e}^{- 2 izk} ( \vert {r}_{t} \vert {e}^{i {ϕ}_{tm}} + {γ}^{′ \vert {r}_{b} \vert {e}^{i ( 2 knH + {ϕ}_{bm} )}} )$$
wherein,
k is the wave number
$$( = \frac{2 π}{λ} )$$
at each interferometer measurement;
zᵢ is the mirror position for each of the i measurements;
ϕ(k) is the wavelength-dependent reflected phase difference, for the respective pairs of reflections, tb (top-bottom), tm (top-mirror), and bm (bottom-mirror);
H is the geometric difference between the interfaces;
n is the refractive index of the structure;
rₘ, rₜ, r_{b} are reflectivities, responsively of the mirror, the top surface and the bottom surface, all being functions of k;
γ is the coherence for OPD 2nH;
γ′ is the coherence for OPD 2(nH−z); and
R is the real function of a function with an imaginary part.

6. The method of claim 1, wherein fitting the multiple measured interferometer spectra comprises minimizes the equation:
$${\sum }_{i = 1}^{N} {\vert {I}_{measured} ( k , {z}_{i} ) - {\vert {r}_{m} \vert}^{2} - {\vert {r}_{t} \vert}^{2} - {\vert {r}_{b} \vert}^{2} - 2 γ [ \vert {r}_{t} {r}_{b} \vert cos ( 2 knH + {ϕ}_{tb} ) ] - 2 R [ \vert {r}_{m} \vert {e}^{- 2 zik} ( \vert {r}_{t} \vert {e}^{i {ϕ}_{tm}} + \vert {r}_{b} \vert {e}^{i ( 2 knH + {ϕ}_{bm} )} ) \vert}^{2}$$

7. A metrology unit for optical critical dimension (OCD) metrology, for characterizing a structure by interferometry, wherein the structure has at least two reflective surfaces, wherein a first surface is separated by a distance greater than a coherence length from at least one second surface, the metrology unit comprising an interferometer and a processor, wherein the processor comprises associated non-transitory memory having instructions that execute a process comprising:
a) setting an interferometry mirror of the system at each of multiple positions z, wherein at each position the mirror reflection is Optical-Path-Difference (OPD) matched with reflection from the first reflective surface, and measuring interferometer spectra I_{measured}, with the mirror at each of the multiple positions;
b) fitting the multiple measured interferometer spectra to an equation for I_{measured}, to solve for non-z-dependent parameters of the equation, leaving a z-dependent function, E₁(k), of the wave number k, with coherent and partially coherent terms; and
c) removing the partially coherent terms of E₁(k) to provide a coherent field E₁(k) Coherent, for characterizing the OCD structure of the first reflective surface.

8. The method of claim 7, further comprising repeating steps a) through c) for at least the second reflective surface, to generate a second z-dependent function, E₂(k), including a fully coherent function, E₂(k)_{Coherent}, and further comprising calculating a derived field E_{Coherent}(k) for characterizing the OCD structure, combining the fully coherent terms of E₁(k) and of E₂(k).

9. The method of claim 8, wherein the second surface is deeper than the first surface and wherein E_{Coherent}(k) is derived by combining the fully coherent terms according to the equation E_{Coherent}(k)=[E₁(k)]_{Coherent}+[E₂(k)]_{Coherent}·e^{ik2Δz}, where Δz is the difference between the two OPD-matched mirror locations for the two surfaces.

10. The unit of claim 8, wherein removing the partially coherent terms of E₁(k) and E₂(k) comprises converting each function by a Fourier transform to an impulse time domain, removing the impulse response associated with the non-OPD-matched portion, and converting the impulse time domain back to the k domain, providing a fully coherent portion of the interferometry field.

11. The unit of claim 7, wherein the equation for I_{measured} is
$${I}_{measured} ( k , {z}_{i} ) = {\vert {r}_{m} \vert}^{2} + {\vert {r}_{t} \vert}^{2} + {\vert {r}_{b} \vert}^{2} + 2 γ [ \vert {r}_{t} {r}_{b} \vert cos ( 2 knH + {ϕ}_{tb} ) ] + 2 R [ \vert {r}_{m} \vert {e}^{- 2 izk} ( \vert {r}_{t} \vert {e}^{i {ϕ}_{tm}} + {γ}^{′ \vert {r}_{b} \vert {e}^{i ( 2 knH + {ϕ}_{bm} )}} )$$
wherein,
k is the wave number
$$( = \frac{2 π}{λ} )$$
at each interferometer measurement;
zᵢ is the mirror position for each of the i measurements;
ϕ(k) is the wavelength-dependent reflected phase difference, for the respective pairs of reflections, tb (top-bottom), tm (top-mirror), and bm (bottom-mirror);
H is the geometric difference between the interfaces;
n is the refractive index of the structure;
rₘ, rₜ, r_{b} are reflectivities, responsively of the mirror, the top surface and the bottom surface, all being functions of k;
γ is the coherence for OPD 2nH;
γ′ is the coherence for OPD 2(nH−z); and
R is the real part of a complex-valued function.

12. The unit of claim 7, wherein fitting the multiple measured interferometer spectra comprises minimizes the equation:
$${\sum }_{i = 1}^{N} {\vert {I}_{measured} ( k , {z}_{i} ) - {\vert {r}_{m} \vert}^{2} - {\vert {r}_{t} \vert}^{2} - {\vert {r}_{b} \vert}^{2} - 2 γ [ \vert {r}_{t} {r}_{b} \vert cos ( 2 knH + {ϕ}_{tb} ) ] - 2 R [ \vert {r}_{m} \vert {e}^{- 2 zik} ( \vert {r}_{t} \vert {e}^{i {ϕ}_{tm}} + \vert {r}_{b} \vert {e}^{i ( 2 knH + {ϕ}_{bm} )} ) \vert}^{2}$$

13. A non-transitory computer readable medium that stores instructions for optical critical dimension (OCD) metrology, for characterizing a structure by interferometry, wherein the structure has at least two reflective surfaces, wherein a bottom surface is separated by a distance greater than a coherence length from at least one top reflective surface, the instructions comprising:
a) setting an interferometry mirror of the system at each of multiple positions z, wherein at each position the mirror reflection is Optical-Path-Difference (OPD) matched with reflection from the at least one top reflective surface, and measuring interferometer spectra I_{measured}, with the mirror at each of the multiple positions;
b) fitting the multiple measured interferometer spectra to an equation for I_{measured}, to solve for non-z-dependent parameters of the equation, leaving a z-dependent function, E₁(k), of the wave number k, with coherent and partially coherent terms; and
c) removing the partially coherent terms of E₁(k) to provide a coherent field E₁(k)_{Coherent}, for characterizing the OCD structure.
